(19) United States
(12) Patent Application Publication
(10) Pub. No.: US 2016/0346763 A1
(43) Pub. Date: Dec. 1, 2016

(54) PHOTOCATALYTIC HYDROGEN PRODUCTION FROM WATER OVER AG-PD-AU DEPOSITED ON TITANIUM DIOXIDE MATERIALS

(71) Applicant: SABIC GLOBAL TECHNOLOGIES B.V., Amsterdam (NL)

(72) Inventors: Ahmed Khaja Wahab, Riyadh (SA); Yahya Al-Salik, Riyadh (SA); Maher Al-Oufi, Riyadh (SA); Shahid Bashir, Riyadh (SA); Hicham Idriss, Riyadh (SA)

(73) Assignee: SABIC Global Technologies B.V., Amsterdam (NL)

(21) Appl. No.: 15/114,908

(22) PCT Filed: Jan. 26, 2015
(86) PCT No.: PCT/IB2015/050583

§ 371 Date: Jul. 28, 2016

Related U.S. Application Data
(60) Provisional application No. 61/937,243, filed on Feb. 7, 2014.

(51) Int. Cl. B01J 23/52; B01J 21/06; C25B 1/00; C01B 3/04; C25B 1/04; B01J 23/50; B01J 35/00

(52) U.S. Cl. CPC B01J 23/52; B01J 23/50; B01J 21/063; B01J 35/0006; B01J 35/0013; B01J 35/004; C01B 3/042; C25B 1/04; C25B 1/003

(57) ABSTRACT

Photocatalysts and methods of using photocatalysts for producing hydrogen from water are disclosed. The photocatalysts comprise photoactive titanium dioxide particles having an anatase to rutile ratio of greater than or equal to 2:1 and silver, palladium, and gold metal material deposited on the surface of the photoactive titanium dioxide particles. The molar ratio of gold to palladium is from 0.1 to 5 and the molar ratio of gold to silver is from 0.1 to 3.

### CROSS REFERENCE TO RELATED APPLICATIONS

This Application claims benefit to U.S. Provisional Application No. 61/937,243 titled “PHOTOCATALYTIC HYDROGEN PRODUCTION FROM WATER OVER AG-PD-AU DEPOSITED ON TITANIUM DIOXIDE MATERIALS” filed Feb. 7, 2014. The contents of the referenced patent application are incorporated into the present application by reference.

### BACKGROUND OF THE INVENTION

A. Field of the Invention

The invention generally concerns photocatalysts that can be used to produce hydrogen from water in photocatalytic reactions. The photocatalysts include titanium dioxide as the photoactive material, with mixtures of anatase and rutile phase titanium dioxide particles. Gold, palladium, and silver can be deposited on the surfaces of the titanium dioxide particles.

B. Description of Related Art

Hydrogen production from water offers enormous potential benefits for the energy sector, the environment, and the chemical industry (Kodama & Gokon, Chem Rev 107:4048, 2007; Connelly & Idriss, Green Chemistry 14:260, 2012; Fujishima & Honda, Nature 238:37, 1972; Kudo & Miseki, Chem Soc Rev 38:253, 2009; Nadeem, et al., Int J Nanotechnology 9:121, 2012; Maeda, et al., Nature 440:2952006). While methods currently exist for producing hydrogen from water, many of these methods can be costly, inefficient, or unstable. For instance, photoelectrochemical (PEC) water splitting requires an external bias or voltage and a costly electrode (e.g., Pt-based).

With respect to photocatalytic electrolysis of water from light sources, while many advances have been achieved in this area (Connelly & Idriss, 2012; Fujishima & Honda, 1972; Kudo & Miseki, 2009; Nadeem, et al., 2012; Maeda, et al., 2006), most materials are either unstable under realistic water splitting conditions or require considerable amounts of other components (e.g., large amounts of sacrificial hole or electron scavengers) to work, thereby offsetting any gained benefits. By way of example, a semiconductor photocatalyst is a material that can be excited upon receiving energy equal to or higher than its electronic band gap. Upon photo-excitation, electrons are transferred from the valence band (VB) to the conduction band (CB), resulting in the formation of an excited electron (in the CB) and a hole (in the VB). In the case of water splitting, electrons in the CB reduce hydrogen ions to H₂ and holes in the VB oxidize oxygen ions to O₂. One of the main limitations of most photocatalysts is the fast electron-hole recombination, a process that occurs at the nanosecond scale, while the oxidation-reduction reactions are much slower (microsecond time scale). Over 90% of photo-excited electron-hole pairs disappear before reaction by radiative and non-radiative decay mechanisms (Yamada, et al., 2009). Current photocatalysts such as those that utilize photoactive materials having a uniform phase structure suffer from these inefficiencies.

### SUMMARY OF THE INVENTION

A solution to the aforementioned inefficiencies surrounding current water-splitting photocatalysts has been discovered. In particular, the solution resides in using a mix of anatase and rutile phase photoactive TiO₂ particles with Au, Pd, and Ag materials deposited on the surface of the particles. Without wishing to be bound by theory, it is believed that using a mixture of anatase and rutile phase photoactive TiO₂ particles at a ratio of at least 2:1 of anatase to rutile reduces the likelihood that an excited electron will spontaneously revert back to its non-excited state (i.e., the electron-hole recombination rate can be reduced or delayed for a sufficient period of time). In particular, it is believed that this ratio allows for the efficient transfer of charge carriers (electrons) from the rutile phase to the anatase phase, where said charge carries in the anatase phase have an increased chance of being transferred to the metal conducting materials rather than undergoing an electron-hole recombination event. Even further, the combination of Au, Pd, and Ag particles has been found to be particularly advantageous, as Pd and Au can conduct excited electrons away from their corresponding holes in the photoactive material and “trap” them at the photocatalyst surface. Au and Ag can enhance performance via resonance plasmonic excitation from visible light, thus allowing the photocatalyst to capture a broader range of light energy. The improved efficiency of the photocatalysts of the present invention allows for a reduced reliance on additional materials such as sacrificial agents, thereby decreasing the complexity and costs associated with using the photocatalysts in water-splitting applications and systems.

In one aspect of the present invention, there is disclosed a photocatalyst comprising a photoactive material comprising TiO₂ particles having an anatase to rutile ratio of greater than or equal to 2:1 and a metal material comprising Ag, Pd, and Au, wherein the molar ratio of Au to Pd is from 0.1 to 5 and the molar ratio of Au to Ag is from 0.1 to 3, wherein the metal material is deposited on the surface of the photoactive material. In other instances, the combination of metals can create a binary metal system rather than a ternary metal system such as Ag+Pd, Ag+Au, or Pd+Au. The anatase to rutile ratio refers to the phase ratios (i.e., amount of each phase present in the photoactive material). This can equate to the weight ratio of anatase to rutile, as the density of anatase to rutile is similar (e.g., density (g/mL): rutile 4.274; anatase: 3.895; brookite: 4.123). The TiO₂ particles can be comprised of a mixture of separate anatase and rutile phase TiO₂ particles. Portions of the surfaces of the anatase and rutile phase particles can be bound together or other in contact with one another to create an interface that includes both anatase and rutile phases. Such interfaces can further enhance the efficiency of the photocatalyst by allowing for the efficient transfer of the excited electrons or charge carries from the rutile phase to the anatase phase, where said charge carries in the anatase phase have an increased chance of being transferred to the metal conducting materials rather than undergoing an electron-hole recombination event. In some mixtures of anatase and rutile phase TiO₂ particles, the anatase particles can have particle sizes between 5 and 50 nm, 5 and 40 nm, 5 and 30 nm, 5 and 20 nm, 5 and 10 nm, 10 and 50 nm, 20 and 50 nm, 30 and 50 nm, or 40 and 50 nm, or any range derivable therein, and the rutile particles can have average particle sizes between 20 and 100 nm, 20 and 90 nm, 20 and 80 nm, 20 and 70 nm, 20 and 60 nm, 20 and 50 nm, 20 and 40 nm, 20 and 30 nm, 30 and 100 nm, 40 and 100 nm, 50 and 100 nm, 60 and 100 nm, 70 and 100 nm, 80 and 100 nm, or 90 and 100 nm, or any range derivable therein. In some mixtures of anatase and rutile phase TiO₂ particles, the anatase particles can have an average particle size of 7 to 10 nm and the rutile particles can have an average particle size of 20 to 30 nm. In some instances, the separate anatase and rutile phase TiO₂ particles are attached to one another. In some instances, the TiO₂ particles further comprise brookite phase particles. The brookite phase particles can be in the form of nano-rods having an average length of 10 to 100 nm, 20 to 100 nm, 30 to 100 nm, 40 to 100 nm, 50 to 100 nm, 60 to 100 nm, 70 to 100 nm, 80 to 100 nm, 90 to 100 nm, 20 to 90 nm, 20 to 80 nm, 20 to 70 nm, 20 to 60 nm, 20 to 50 nm, 20 to 40 nm, 20 to 30 nm, or any range derivable therein, and an average width of less than 20 nm. In some instances, the photoactive material of the invention comprises a mixture of anatase particles, rutile particles, and brookite particles, each particle having its own characteristic phase. The photoactive material of the invention can also comprise mixed-phase TiO₂ particles comprising anatase phase and rutile phase TiO₂ within the same material (e.g., within same particle or film). The photoactive material may further comprise Si⁴⁺ as an interstitial dopant in an amount less than 5, 4, 3, 2, or 1 wt %, which is thought to further decrease the rate of electron-hole recombination in the photoactive material. Advantageously, it was found that metal material dispersed on the surface of the photoactive material increases the efficiency of water splitting reactions. The metal material can comprise separate particles of pure Au, Pd, and Ag, or can comprise alloy particles of these metals. By way of example, the metal material can comprise Ag particles, Pd particles, Au particles, tertiary alloy particles of Au, Pd, and Ag, binary alloy particles of Au and Pd, binary alloy particles of Au and Ag, binary alloy particles of Pd and Ag, etc., or any combination thereof. In preferred aspects, said combination of metal material particles results in the presence of Au, Pd, and Ag on the surface of the photoactive material. The Au and Pd are capable of trapping electrons from the conduction band of the TiO₂ particles, which is believed to decrease the rate of electron-hole recombination, making it more likely that the trapped electron will be used to reduce hydrogen ions. Without wishing to be bound by theory, it is believed that the presence of Ag and/or Au allows more energy to be harvested from the sun (either by direct electric field or by hot electron mechanism or both, and the presence of Pd is needed to keep Ag or Au in its metallic state, to pump electrons away from the conduction band, as well as for fast H atoms recombination to molecular hydrogen. The molar ratio of Au to Pd can be from 0.1 to 5, 0.5 to 5, 1 to 5, 2 to 5, 3 to 5, 4 to 5, 0.1 to 4, 0.1 to 3, 0.1 to 2, 0.1 to 1, 0.1 to 0.5, or any range derivable therein. The molar ratio of Au to Ag can be from 0.1 to 3, 0.5 to 3, 1 to 3, 2 to 3, 0.1 to 2, 0.1 to 1, 0.1 to 0.5, or any range derivable therein. In a preferred embodiment, the molar ratio of Au to Pd is about 1:3 and the molar ratio of Au to Ag is about 1:1. In particular embodiments, both the TiO₂ particles and the metal material are in the form of nanostructures. The nanostructures can be nanowires, nanoparticles, nanoclusters, or nanocrystals, or combinations thereof. In some embodiments the Ag particles have an average particle size of less than 10 nm, the Pd particles have an average particle size of less than 2 nm, the Au particles have an average particle size of less than 5 nm, the tertiary alloy particles of Au, Pd, and Ag have an average particle size from 5 to 10 nm, the binary alloy particles of Au and Pd have an average particle size from 5 to 10 nm, and/or the binary alloy particles of Au and Ag have an average particle size from 5 to 10 nm and/or the binary alloy particles of silver and palladium have an average particle size from 0.5 to 10 nanometers. In particular embodiments, it was found that low amounts of metal materials can be used and still efficiently split water and create hydrogen gas. Such amounts can be less than 5, 4, 3, 2, 1, or 0.5 wt % of the total weight of the photocatalysts. In a non-limiting embodiment, a catalyst can include 0.1 wt % Ag and 0.3 wt. % of Pd on TiO₂ in pure anatase from with dimensions of 6 to 7 nm. Also, the metal material can cover less than 50, 40, 30, 20, 10, or 5% of the surface area of the photoactive metal oxide semiconductor or can cover from about 0.0001 to 5% of the total surface area of the photoactive material and still efficiently produce hydrogen from water. The photocatalyst can be self-supported (i.e., it is not supported by a substrate) or it can be deposited onto a substrate. Non-limiting examples of substrates include indium tin oxide substrate, a stainless steel substrate, silicon oxide, aluminum oxide, zirconium oxide, or magnesium oxide. The photocatalysts of the present invention are capable of splitting water in combination with a light source. No external bias or voltage is needed to efficiently split water. The hydrogen production rate from water can be modified as desired by increasing or decreasing the amount of light or light flux that the system is subjected to. In particular aspects, the photocatalysts of the present invention can be used in water splitting systems to provide a hydrogen production rate from water between 5×10⁻⁵ and 5×10⁻⁴ mol/g_{Catal} min with a light source having a flux from about 0.3 to 10 mW/cm², or from 0.5 to 2 mW/cm². In some aspects, the ratio of H₂ to CO₂ produced is from 2.5 to 1 to 60 to 1, or from 2.5 to 1 to 10 to 1, indicating substantial H₂ production from water as opposed to from sacrificial agent alone. In addition to being capable of catalyzing water splitting without an external bias or voltage, the photocatalysts of the present invention can be comprised in an anode of an electrochemical cell capable of forming oxygen and hydrogen by electrolysis of water. In some instances, the photocatalysts of the present invention are capable of catalyzing the photocatalytic oxidation of an organic compound.

Also disclosed is a composition comprising a photocatalyst of the invention, water, and a sacrificial agent that can be used for water splitting. With a light source, the water can be split and hydrogen and oxygen gas formation can occur. In particular instances, the sacrificial agent may further prevent electron/hole recombination. In some instances, the composition comprises 0.1 to 2 g/L of the photocatalyst. Notably, the efficiency of the photocatalysts of the present invention allows for one to use substantially low amounts (or none at all) of sacrificial agent when compared to known systems. In particular instances, 0.1 to 10 w/v %, or preferably 2 to 7 w/v %, of the sacrificial agent can be included in the composition. Non-limiting examples of sacrificial agents that can be used include methanol, ethanol, propanol, methyl tertio-butyl ether, ethylene glycol, propylene glycol, glycerol, oxalic acid, or any combination thereof. In particular aspects, ethylene glycol, glycerol, or a combination thereof is used.

In another aspect of the present invention there is disclosed a system for producing hydrogen gas and/or oxygen gas from water. The system can comprise a container (e.g., transparent or translucent containers or opaque containers such as those that can magnify light (e.g., opaque container having a pinhole(s)) and a composition that includes photocatalyst of the present invention, water, and optionally a sacrificial agent. The container in particular embodiments is transparent or translucent. The system can also include a light source for irradiating the composition. The light source can be natural sunlight or can be from a non-natural or artificial source such as a UV lamp. While the system can use an external bias or voltage, such an external bias or voltage is not needed due to the efficiency of the photocatalysts of the present invention.

In another embodiment, there is disclosed a method for producing hydrogen gas by photocatalytic electrolysis, the method comprising irradiating an aqueous electrolyte solution comprising any of the compositions described above with light in an electrolytic cell having an anode and a cathode, the anode comprising any of the photocatalysts described above, whereby a voltage between the anode and the cathode is produced and water molecules are split to form hydrogen and oxygen. The method can be practiced such that the hydrogen production rate from water can be modified as desired by increasing or decreasing the amount of light or light flux that the system is subjected to. In particular aspects, the method can be practiced such that the hydrogen production rate from water is between 5×10⁻⁵ to 5×10⁻⁴ mol/g_{Catal} min with a light source having a flux from about 0.3 to 2 mW/cm². In some aspects, the ratio of H₂ to CO₂ produced is from 5 to 1 to 10 to 1, indicating substantial H₂ production from water as opposed to from sacrificial agent alone. In particular embodiments, the light source can be natural sunlight. However, non-natural or artificial light sources (e.g., ultraviolet lamp, infrared lamp, etc.) can also be used alone or in combination with said sunlight.

The following includes definitions of various terms and phrases used throughout this specification.

“Water splitting” or any variation of this phrase describes the chemical reaction in which water is separated into oxygen and hydrogen.

“Inhibiting,” “preventing,” or “reducing” or any variation of these terms, when used in the claims or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole. In either instance, the photocatalysts of the present invention can be compared with photocatalysts that do not have a mixture of anatase particles to rutile phase particles at a ratio of 2:1 or greater and/or do not have metal material having each of Au, Pd, and Ag.

“Effective” or any variation of this term, when used in the claims or specification, means adequate to accomplish a desired, expected, or intended result.

“Nanostructure” refers to an object or material in which at least one dimension of the object or material is equal to or less than 100 nm (e.g., one dimension is 1 to 100 nm in size). In a particular aspect, the nanostructure includes at least two dimensions that are equal to or less than 100 nm (e.g., a first dimension is 1 to 100 nm in size and a second dimension is 1 to 100 nm in size). In another aspect, the nanostructure includes three dimensions that are equal to or less than 100 nm (e.g., a first dimension is 1 to 100 nm in size, a second dimension is 1 to 100 nm in size, and a third dimension is 1 to 100 nm in size). The shape of the nanostructure can be of a wire, a particle, a sphere, a rod, a tetrapod, a hyper-branched structure, or mixtures thereof.

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts and photoactive materials of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1: Illustration of photoactive material comprising anatase and rutile phase particles in which the particles are in contact with one another: (A) larger anatase particles; (B) larger rutile phase particles; (C) similar sized particles; (D) films of anatase and rutile.

FIG. 2: Illustration of a photoactive catalyst of the present invention.

FIG. 3: Schematic diagram of a water splitting system of the present invention.

FIG. 4: XRD data confirming the tuning of anatase/rutile ratios to the desired ratios.

FIG. 5: Rate of hydrogen and CO₂ photocatalytic production from water and 5 vol. % of ethylene glycol over a series of Au—Pd/TiO₂ catalysts.

FIG. 6A: Graph of plasmon response of a series of Au—Pd/TiO₂ catalysts

FIG. 6B: Rates of hydrogen production of a series of Au—Pd/TiO₂ catalysts

FIG. 6C: Plasmon-TiO₂ schematic of water-splitting.

FIG. 6D: Transmission electron microscopy in bright and dark field modes of gold particles on TiO₂.

FIG. 7: Hydrogen production from water in presence of ethylene glycol (5 vol. %) at different catalyst loadings at the indicated concentrations. Catalyst: 0.65 wt % Au-0.45 wt % Pd—TiO₂(A+R).

FIG. 8: Rate of H₂ production over 0.4 wt % Au-0.65 wt % Pd—TiO₂ (A+R) with different amount of catalyst concentration.

FIG. 9A: High resolution dark field Transmission Electron Microscope TEM) image.

FIG. 9B: Graph of hydrogen production from water, in presence of 5 vol. % of glycerol, as a function of time over Ag—Pd/TiO₂ catalysts.

FIG. 9C: Graph of CO₂ production as function of time for the same catalysts in FIG. 9B.

FIG. 9D: Graph of the solar to hydrogen efficiency as a function of amount of catalysts for 0.1 wt. % Ag-0.3 wt. % Pd/TiO₂ conducted with a light composed of both UV and Visible photons and with intensity close to that of the sun hitting the earth surface at midday (total UV+Vis flux=about 100 mW/cm2).

### DETAILED DESCRIPTION OF THE INVENTION

While hydrogen-based energy from water has been proposed by many as a solution to the current problems associated with carbon-based energy (e.g., limited amounts and fossil fuel emissions), the currently available technologies are either expensive, inefficient, or unstable. The present application provides a solution to these issues. The solution is predicated on the use of photocatalysts that employ anatase phase and rutile phase photoactive TiO₂ semiconductor materials at a ratio of anatase phase to rutile phase of 2:1 or greater in combination with Au, Pd, and Ag metal particles. This combination results in efficient photocatalysts that can be used in water-splitting applications, in which the amount of sacrificial agents used in said applications can be substantially reduced or avoided altogether.

These and other non-limiting aspects of the present invention are discussed in further detail in the following sections.

### A. Photoactive Catalysts

The photoactive material includes titanium dioxide. Titanium dioxide can be in the form of three phases, the anatase phase, the rutile phase, and the brookite phase. Anatase and rutile phases have a tetragonal crystal system, whereas the brookite phase has an orthorhombic crystal system. Each of the different phases can be purchased from various manufactures and supplies (e.g., Titanium (IV) oxide anatase Nano powder and Titanium (IV) oxide rutile Nano powder in a variety of sizes and shapes can be obtained from Sigma-Aldrich® Co. LLC (St. Louis, Mo., USA) and from Alfa Aesar GmbH & Co KG, A Johnson Matthey Company (Germany)); Enamel Grade Titanium dioxide (Brookite) from Yixing Zhenfen Medical Chemical Co., Ltd. (China); all phases of titanium dioxide from L.E.B. Enterprises, Inc. (Hollywood, Fla. USA)). Alternatively, the photoactive material can be made by any process known by those of ordinary skill in the art (e.g., precipitation/co-precipitation, sol-gel, template/surface derivatized metal oxide synthesis, solid-state synthesis of mixed metal oxides, micro emulsion technique, solvothermal, sonochemical, combustion synthesis, etc.).

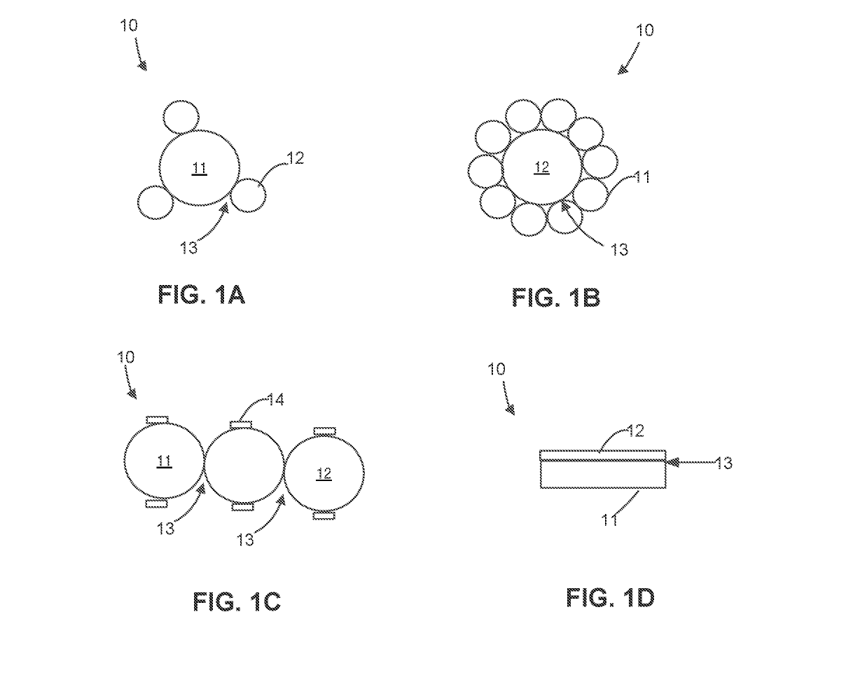

Referring to FIG. 1, photoactive material 10 of the present invention can take a variety of different forms. By way of example only, anatase particles 11 can be larger than rutile phase particles (FIG. 1A). Alternatively, rutile particles 12 can be larger than anatase particles 11 (FIG. 1B). Still further, anatase 11 and rutile 12 particles can be substantially the same size (FIG. 1C). Brookite particles 14 can also be included in the photoactive material 10 (FIG. 1C). While the particles in FIG. 1 are illustrated as spheres, other shapes such as rod-shaped and irregularly shaped particles are contemplated. In other instances, the anatase 11 and rutile 12 phases can be formed into sheets or films (FIG. 1D). Alternatively, and not shown, the photoactive material 10 can be a mixed-phase such that each particle or film contains both anatase and rutile phases or each particle or film contains each of anatase, rutile, and brookite phases. In either instance (i.e., separate or mixed-phase titanium dioxide material), an interface 13 can be created between the anatase/rutile/brookite material. Such interface 13 can result in an increase in photocatalytic activity. Notably, it was discovered that when a ratio of anatase to rutile of 2:1 or greater is used, the photocatalytic activity of the photoactive material (10) can be substantially increased. As explained above, it is believed that this ratio allows for the efficient transfer of charge carriers (electrons) from the rutile phase to the anatase phase, where said charge carries in the anatase phase have an increased chance of being transferred to the metal conducting materials rather than undergoing an electron-hole recombination event.

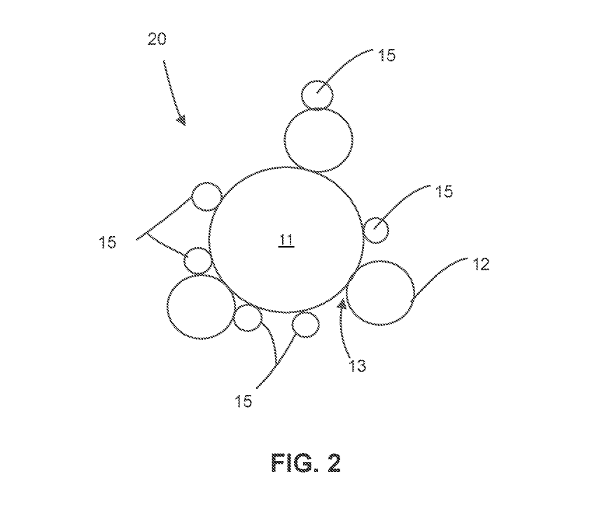

With respect to the metal material (i.e., gold, silver, and palladium), it can also be obtained from a variety of commercial sources in a variety of forms (e.g., particles, rods, films, etc.) and sizes (e.g., Nano scale or Micro scale). By way of example, each of Sigma-Aldrich® Co. LLC and Alfa Aesar GmbH & Co KG offer such products. Alternatively, they can be made by any process known by those of ordinary skill in the art. In a non-limiting aspect, the metal particles (element 15 in FIG. 2) can be prepared using co-precipitation or deposition-precipitation methods (Yazid et al., Turk J Chem 34:639-50, 2010). The metal particles 15, can be used as conductive material for the excited electrons to ultimately reduce hydrogen ions to produce hydrogen gas. The metal particles 15 can be substantially pure particles 15 of Au, Pd, and Ag. The metal particles 15 can also be binary or tertiary alloys of Au, Pd, and/or Ag. The metal particles 15 are highly conductive materials, making them well suited to act in combination with the photoactive material 10 to facilitate transfer of excited electrons to hydrogen before an electron-hole recombination event occurs or by increasing the time that such an event occurs. The metal particles 15 can also enhance efficiency via resonance plasmonic excitation from visible light, enabling capture of a broader range of light energy. The metal particles 15 can be of any size compatible with the photoactive material 10. In some embodiments, the metal particles 15 are nanostructures. The nanostructures can be of any form suitable for use in the photoactive catalytic systems of the present invention, including but not limited to nanowires, nanoparticles, nanoclusters, nanocrystals, or combinations thereof.

Referring to FIG. 2, the photoactive catalysts 20 of the present invention can be prepared from the aforementioned photoactive material 10 and the metal particles 15 by using the process described in the Examples section of this specification. Other optional methods that can be used to make the photoactive catalysts 20 of the present invention include formation of aqueous solutions of titanium dioxide ions in the presence of Au, Ag, and Pd particles 15 followed by precipitation, where the metal particles 15 are attached to at least a portion of the surface of precipitated titanium dioxide crystals or particles 11, 12. Alternatively, the metal particles 15 can be deposed on the surface of the titanium dioxide particles 11, 12, by any process known by those of ordinary skill in the art. Deposition can include attachment, dispersion, and/or distribution of the metal particles 15 on the surface of the photoactive material 10 or TiO₂ particles 11, 12. As another non-limiting example, the photoactive material 10 or TiO₂ particles 11, 12 can be mixed in a volatile solvent with the metal particles 15. After stirring and sonication, the solvent can be evaporated off. The dry material can then be ground into a fine powder and calcined (such as at 300° C.) to produce the photoactive catalysts 20 of the present invention. Calcination (such as at 300° C.) can be used to further crystalize the titanium dioxide particles 11, 12 or material 10. In some embodiments, the photoactive material 10 or silicone dioxide particles 11, 12, thereof, includes Si⁴⁺ ions as an interstitial dopant, such as by sol-gel or dip-coating techniques, as disclosed in Barakat et al., J Nanosci. Nanotechnol. 10:1-7, 2005.

### B. Water-Splitting System

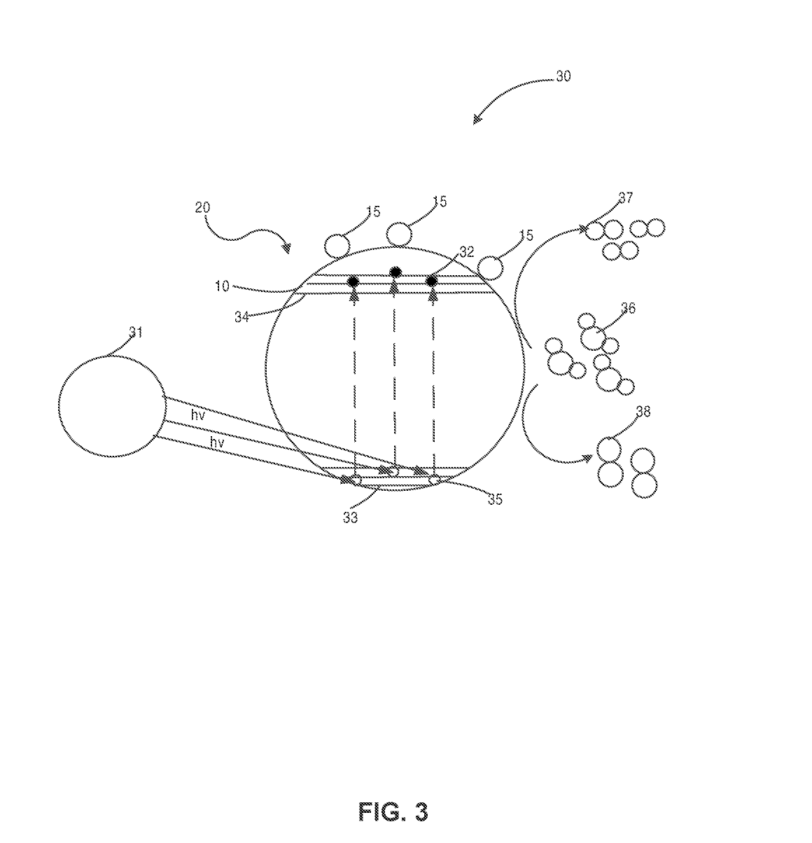

Referring to FIG. 3, a non-limiting representation of a water-splitting system 30 of the present invention is provided. The system includes the photoactive material 10, metal particles 15 attached to the surface of said material 10, and a light source 31. The photoactive catalyst 20 can be used as the anode in a transparent container containing an aqueous solution and used in a water-splitting system. An appropriate cathode can be used such as Mo—Pt cathodes (See, for example, International Journal of Hydrogen Energy, 2006, Vol. 31, Issue 7, pages 841-846, the contents of which are incorporated herein by reference) or MoS₂ cathodes (See, for example, International Journal of Hydrogen Energy, 2013, Vol. 38, Issue 4, pages 1745-1757, the contents of which are incorporated herein by reference). Alternatively, the container can be translucent or even opaque such as those that can magnify light (e.g., opaque container having a pinhole(s)). The photocatalyst 20 can be used to split water 36 to produce H₂ and O₂. The light source 31 (e.g., natural sunlight or artificial light such as from a UV lamp or IR lamp) contacts the photoactive material 10, thereby exciting electrons 32 from their valence band 13 to their conductive band 34, thereby leaving a corresponding hole 35. The excited electrons 32 are used to reduce hydrogen ions to form hydrogen gas 37, and the holes 35 are used to oxidize oxygen ions to oxygen gas 38. The hydrogen gas and the oxygen gas can then be collected and used in down-stream processes. Due to the highly conductive metal particles 15 dispersed on the surface of the photoactive material 10, excited electrons 32 are more likely to be used to split water before recombining with a hole 35 than would otherwise be the case. Notably, the system 30 does not require the use of an external bias or voltage source. Further, the efficiency of the system 30 allows for one to avoid or use minimal amounts of a sacrificial agent such as methanol, ethanol, propanol, methyl tertio-butyl ether, ethylene glycol, propylene glycol, glycerol, oxalic acid, or any combination thereof. In certain aspects, however, 0.1 to 10 w/v %, or preferably 2 to 7 w/v %, of a sacrificial agent can be included in the aqueous solution. The presence of the sacrificial agent can increase the efficiency of the system 30 by further reducing the likelihood of hole/electron recombination via oxidation of the sacrificial agent by the hole rather than recombination with the excited electron. Preferred sacrificial agents ethylene glycol, glycerol, or a combination thereof is used.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Production of Photocatalysts

Synthesis of Ag—Pd—TiO₂ (Anatase+Rutile) Alloy:

TiO₂ (Anatase (A)+Rutile (R)) was prepared independently and also purchased commercially (Sigma). The Sigma TiO₂ contains anatase and rutile in 85:15 ratio while that prepared was either from initially commercial TiO₂ (anatase) with particle size of about 15 nm or by the sol-gel method (See, International Application Publication No. WO 2013/159894) giving anatase particles of about the same size. AgNO₃ (Sigma Aldrich®, 100%) and Pd (CH₃COO)₂ (Sigma Aldrich®, 99.9%) were used as precursors for Ag and Pd, respectively. A stock solution of AgNO₃ in water, Pd(CH₃COO)₂ and 16 vol. % acetic acid in water were directly poured on the support with the required amount to get the desired metal loading. A stock solution of polyvinyl alcohol (PVA) in water was used as a surfactant where the PVA to metal ratio was 10 wt. %. Ethylene glycol (15 mL) was used as the reducing agent. The mixture of TiO₂, metals, PVA and ethylene glycol were stirred and heated at 180 to 200° C. for 12 to 24 hour in a round bottom flask equipped with a condenser. The mixture was then poured into an empty beaker and heated over a heating plate until all water has evaporated while stirring. The resulting solid was then scratched out of the beaker using a glass rod and dried in an oven at 100-110° C. for 12 hour followed by calcination at 350° C. for 5 h. Table 1 provides a summary of the produced catalysts.

TABLE 1

| Ag (wt. %) | Pd (wt. %) | TiO₂ (g) | Ag (g) | Pd (g) |
|---|---|---|---|---|
| 0.2 | 0.8 | 2 | 0.004 | 0.016 |
| 0.4 | 0.6 | 2 | 0.008 | 0.012 |
| 0.5 | 0.5 | 2 | 0.01 | 0.01 |
| 0.6 | 0.4 | 2 | 0.012 | 0.008 |
| 0.8 | 0.2 | 2 | 0.016 | 0.004 |

Synthesis of Au—Pd TiO₂ (A+R) Alloy:

Au—Pd/TiO₂ catalysts were synthesized by co-impregnation method to obtain different metal loading (1.22, 0.13, 0.06 and 0.04 wt. % of gold, and 1.97, 0.20, 0.10 and 0.07 wt % of Pd) in a 1:3 molar ratio. The precursors of gold and palladium were AuCl₄ (dissolved in aqua regia) and PdCl₂ in 1 normal HCl. TiO₂ semiconductor about 85% anatase and 15% Rutile was used as a support martial. Firstly, TiO₂ was placed into Pyrex beaker. Then, the aqua regia solution of Au and Pd in 1 normal HCl were respectively poured into a certain amount of TiO₂ under magnetic stirring (170 rpm) at 80° C. for 12 to 24 hour. The precipitate formed was dried for >4 h, at 120° C. Finally, the material was calcined at 300° C. for five hours; afterward it was crushed using a mortar to fine powder. Table 2 provides a summary of the produced catalysts.

TABLE 2

| Catalyst | Au (wt. %) | Pd (wt. %) | Au (atomic %) | Pd (atomic %) |
|---|---|---|---|---|
| S1 | 1.96 | 1.06 | 0.81 | 0.81 |
| S2 | 2.38 | 0.65 | 0.98 | 0.49 |
| S3 | 1.45 | 1.57 | 0.59 | 1.19 |
| S4 | 2.54 | 0.46 | 1.05 | 0.35 |
| S5 | 1.15 | 1.86 | 0.47 | 1.41 |
| S6 | 2.29 | 3.72 | 0.95 | 2.86 |
| S7 | 0.40 | 0.65 | 0.16 | 0.49 |
| S8 | — | 3.00 | — | — |
| S9 | 3.00 | — | — | — |

Synthesis of Ag—Au—Pd TiO₂ (A+R) Alloy:

Ag—Au—Pd TiO₂ (A+R) Alloy was also prepared via the same co-impregnation method discussed above for the Au—Pd TiO₂ (A+R) Alloy. TiO₂ semiconductor having about 85% anatase and 15% Rutile was used as a support martial. Table 3 provides a summary of the produced catalyst.

TABLE 3

| Catalyst | Ag (wt. %) | Au (wt. %) | Pd (wt. %) |
|---|---|---|---|
| S10 | 0.66 | 1.21 | 0.67 |

Characterization of Photocatalysts:

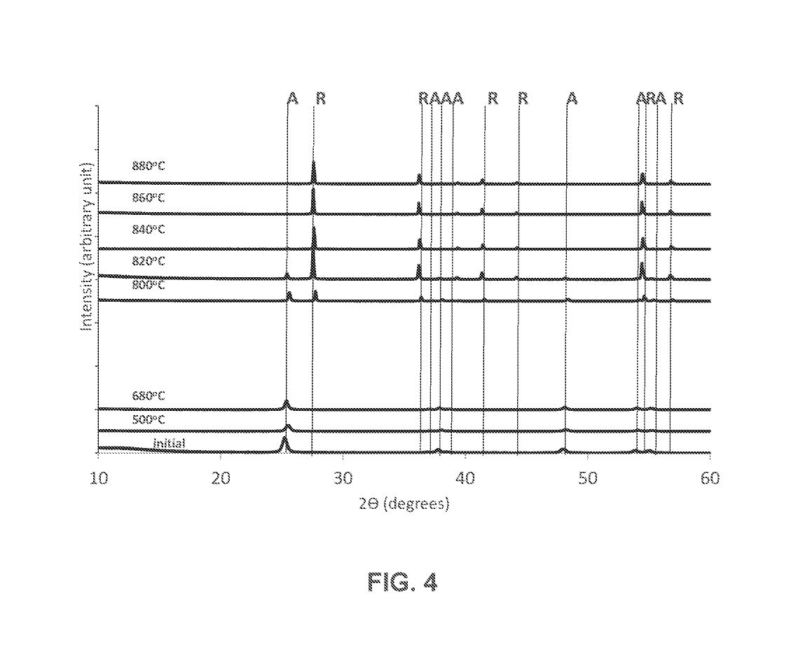

Characterization of the produced photocatalysts was performed with bET surface areas determination, XRD diffraction, X-ray photoelectron spectroscopy, Raman spectroscopy, and transmission electron microscopy. FIG. 4 provides data concerning an XRD study with different anatase/rutile ratios that had been heated at an initial temperature (bottom line), 500° C., 680° C., 800° C., 820° C., 840° C., 860° C., 880° C. R refers to rutile phase and A refers to anatase phase. The metals are not seen by XRD due to their concentrations being too weak to detect.

UV Absorption:

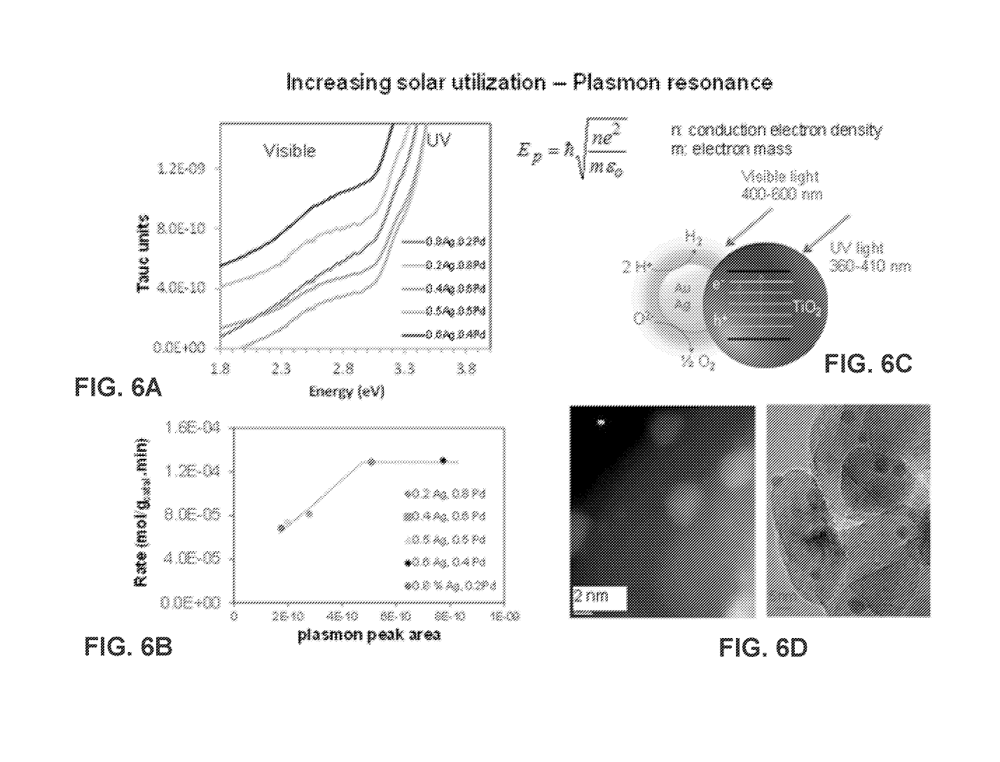

UV-Vis absorbance spectra of the powdered catalysts were collected over the wavelength range of 250-900 nm on a Thermo Fisher Scientific UV-Vis spectrophotometer equipped with praying mantis diffuse reflectance. Samples were grounded using mortar and pestle before introducing into the praying mentis chamber using a sample cup. Reflectance (% R) of the samples was measured. The reflectance (% R) data was used to calculate the band gap of the samples using the Tauc plot (Kubelka-Munk function). A 100 Watt ultraviolet lamp (H-144GC-100, Sylvania par 38) was used as a UV source with a flux of up to 3 mW/cm², depending on the distance from the source, with the cut off filter (360 nm and above). FIG. 6A shows a typical UV-Vis absorption spectrum plasmon response; in this case of one of the Ag—Pd series having the weight concentrations of 0.6Ag/0.4Pd; 0.2Ag/0.08Pd; 0.8 Ag/0.2Pd; 0.4Ag/0.6Pd; and 0.5Ag/0.5Pd, respectively. The Ag plasmon resonance can be seen by the absorption in the visible between 2.3 to ca. 3.0 eV, the rise above 3.0 eV is due to the absorption of TiO₂. The Kubelka-Munk function, F(R)=(1−R)²/(2R), was used to calculate the optical absorbance from the reflectance (R) of the samples compared to the standard. Band gap was estimated from the Tauc plot of the quantity (F(R) E)^{1/2} against the radiation energy.

### Example 2

### Use of Photocatalysts in Water-Splitting Reactions

Experimental Set-Up:

Catalytic reactions were conducted in batch reactors with total volumes of between 0.1 and 1 L. Sacrificial agent was present in concentrations between 1 and 10 v/v %. Sacrificial agents used were methanol, ethanol, propanol, ethylene glycol, glycerol, and oxalic acid, with ethylene glycol and glycerol showing the best performance. Photocatalyst was used in concentrations between 0.1 and 0.5 g/L. Reaction mixtures were irradiated with sunlight, with a light flux at the front side of the reactor of between 0.3 and 1 mW/cm². In situ FT-IR and gas chromatography were used to measure gas production. Hydrogen production rates were between 5×10⁻⁵ to 5×10⁻⁴ mol/g_{Catal} min. The ratio of H₂ to CO₂ produced was between 5 to 1 and 10 to 1, indicating that large amounts of the hydrogen produced is from water as opposed to sacrificial agent. Catalyst stability was tested up to 350 hours under direct sunlight, and performance was maintained as long as 1% of sacrificial agent was present.

Binary System:

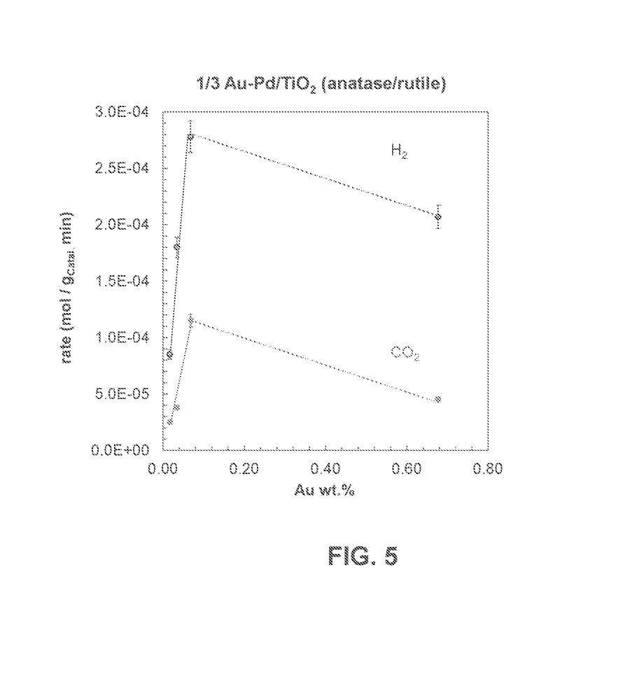

FIG. 5 shows a representative data of the activity of Au—Pd/TiO₂(A+R) as a function of Au loading at a constant Au to Pd molar ratio of 1 to 3. The rate is provided for hydrogen and CO₂ under direct sun light. To extract the rate measurement of hydrogen concentrations were conducted as function of time. Division of the obtained concentration of H₂ (and CO₂) by time gives the volumetric reaction rate which is then converted into rate per mass knowing the catalyst concentration in the reactor. It is evident that both H₂ and CO₂ track each other where hydrogen is produced from both water and the sacrificial agent (ethylene glycol in this case). As can be seen in FIG. 5 the ratio H₂/CO₂ is not constant, however it does change with catalyst and oscillates between 2.4 to 4.7. On other catalysts ratios up to 10 were observed. The formation of CO₂ is due to successive electron donation for ethylene glycol and carbon-carbon bond dissociation and water gas shift some of these reactions can be summarized as follow:

HOCH₂CH₂OH+2O(s)→(a)OCH₂CH₂O(a)+2OH(a)

(a)OCH₂CH₂O(a)+4h⁺+2O(s)→OCH—CHO+2OH(a)

OCH—CHO→2CO+H₂

2CO+2H₂O→2CO₂+2H₂

4OH(a)+4e⁻→2H₂+4O(s)

Total:HOCH₂CH₂OH+2H₂O→2CO₂+5H₂.

Relationship Between the Plasmon Resonance of Ag and the Reaction Rate:

FIG. 6B presents evidence of plasmon effect on hydrogen production from water. A series of Ag—Pd deposited on TiO₂ (A+R) was studied. FIG. 6B is a graph of plasmon peak area for vaious catalyst concentrations versus rate of reaction rate in mol/gcat.-min. FIG. 6B indicated a relationship between the plasmon peak area and the reaction rate. The plasmon peak area of Ag and Ag—Pd alloy was obtained from the UV-Visible spectrum depicted in FIG. 6A. This can be seen in the visible range extending from 2.3 to about 3 eV. The light absorption above 3 eV is due to TiO₂. FIG. 6C a schematic of the reaction in which TiO₂ (absorption above 3 eV) and Ag—Pd (absorption below 3 eV). FIG. 6D are TEM micrographs of gold particles (dark circles of about 5 nm in size). One can also see in the dark field mode smaller particles of Pd and Au separated in as alloys.

Ternary System:

The Au—Pd—Ag/TiO₂ (A+R) catalyst S10 was also tested for its ability to be used as a photocatalyst in a water-splitting reaction. Table 4 presents representative data of the activity of ternary system in which the molar ratio of the three metals is kept at 1. The rate of reaction while comparable to that observed on the binary system the catalyst showed high activity at low sacrificial agent (ethylene glycol) concentrations. There is no noticeable difference between the use of 1% and 5% of sacrificial agent.

TABLE 4

| Ethylene Glycol % | Hydrogen Production Rate (mol/g_{Catal} min) |
|---|---|
| 1 | 6.9 × 10⁻⁵ |
| 2 | 6.9 × 10⁻⁵ |
| 3 | 8.0 × 10⁻⁵ |
| 4 | 8.7 × 10⁻⁵ |
| 5 | 8.0 × 10⁻⁵ |

### Example 3

### Optimization of the Amount of Catalyst for Photo-Catalytic Water-Splitting

Experimental Set-Up:

0.65 wt. % Au and 0.45 wt. % Pd—TiO₂ (A+R) catalyst was evaluated for hydrogen production in a 100 ml volume Pyrex glass reactor. Catalyst concentration was varied from 0.25-1.25 g/L. The reactor was purged with nitrogen gas for 30 min in order to remove oxygen gas. Milli-Q deionized water (20 ml) and the sacrificial agent (1 ml, i.e. 5% by volume) of ethylene glycol were added into the reactor. The final mixture was subjected to constant stirring initially under dark condition for 30 minutes to get better dispersion of catalyst powder and the sacrificial agent in the water mixture. The reactor was then exposed to the UV light. A 100 Watt ultraviolet lamp (H-144GC-100, Sylvania par 38) was used as a UV source with a flux of ca. 1 mW/cm² at a distance of 10 cm with the cut off filter (360 nm and above). Product analyses were performed by Gas Chromatography (GC) equipped with Thermal Conductivity Detector (TCD) and Haysep Q packed column at 45° C. and N₂ was used as a carrier gas.

Effect of Catalysts Concentration:

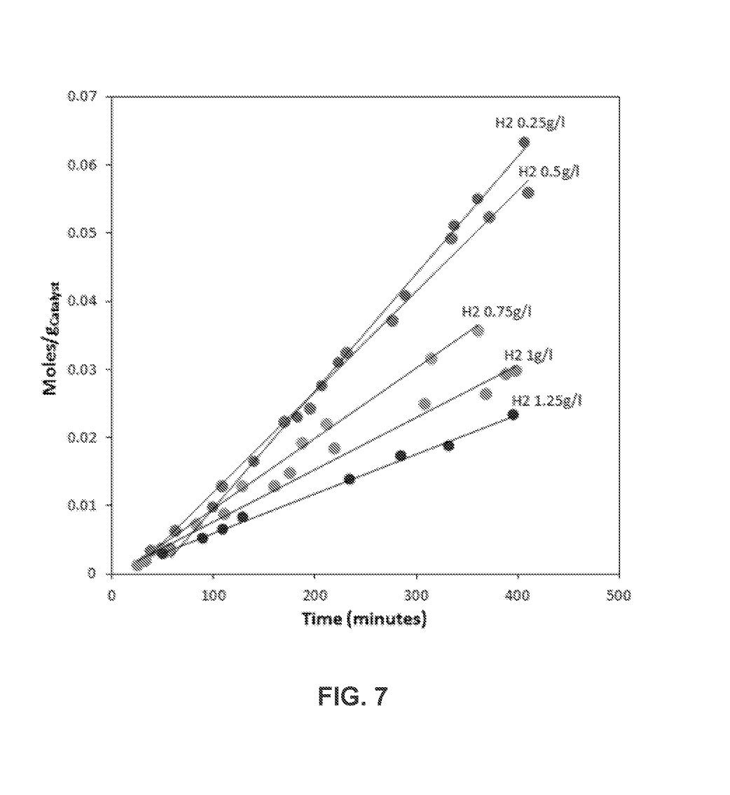

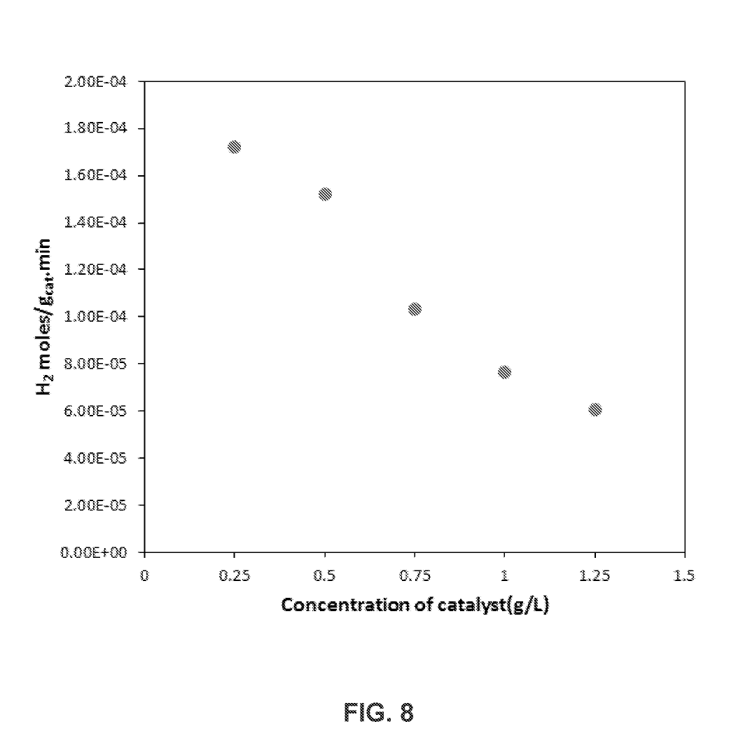

FIGS. 7 and 8 present hydrogen production rates as a function of catalysts concentrations inside a 100 mL reactor. FIG. 7 is a graph of time in minutes versus moles/g_{catalyst} for catalyst concentrations of 0.25 g/L (top line), 0.5 g/L (second line from top), 0.75 g/L (third line from the top), 1 g/L (second line from the bottom), and 1.25 g/L (bottom line). FIG. 8 is graph of the same concentrations of catalyst (g/L) versus rate of hydrogen product in moles/g_{cat}-min. The decrease in the rate is due to a combination of shadowing and scattering. It may also be due to increasing H₂ and O₂ recombination centers inside the reactor (metals such as Pd are active in pumping electrons from the conduction band and also for the combustion of H₂ back to water).

### Example 4

### Photo-Catalytic Water-Splitting

0.1 wt. % Ag-0.3 wt. % Pd/TiO₂ and 0.3 wt. % Ag-0.1 wt. % Pd.

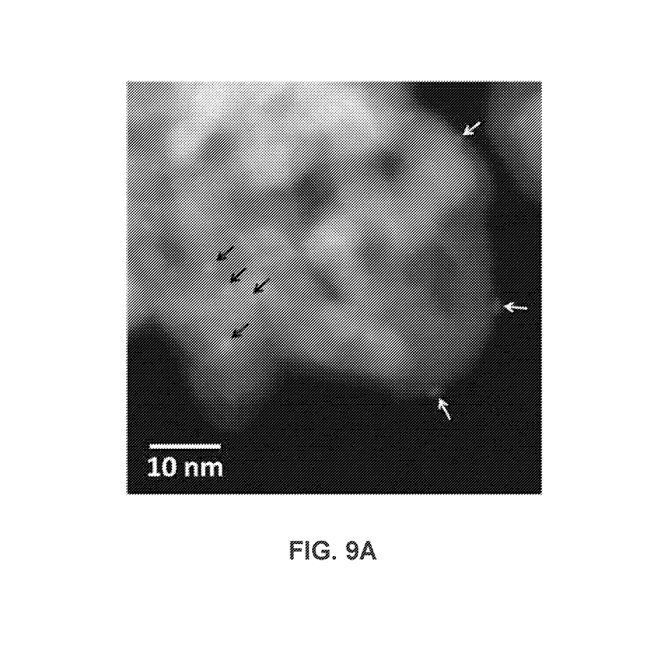

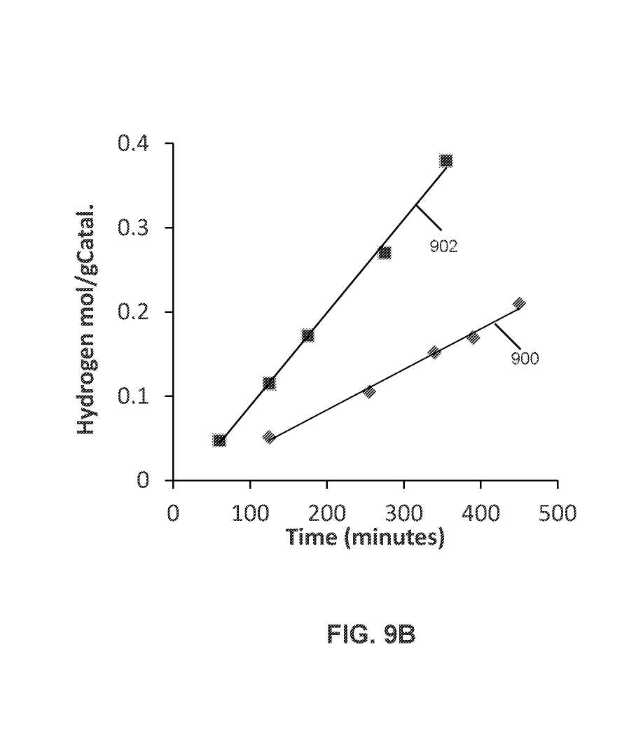

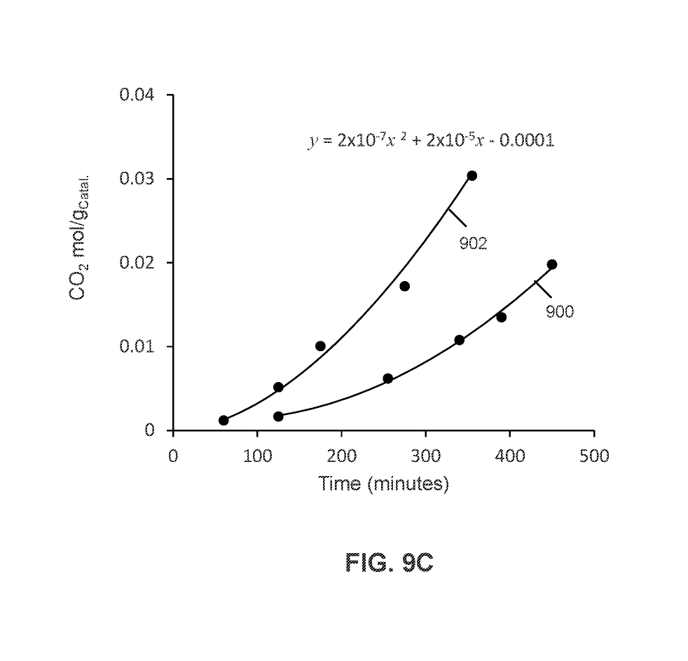

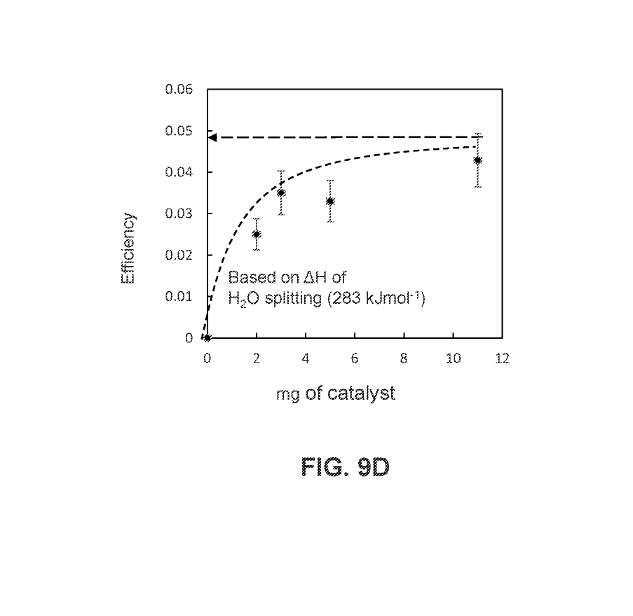

An (A+R) catalyst based on Ag—Pd/TiO₂ was evaluated for photo-catalytic water splitting. The TiO₂ is composed of nano-particles in pure anatase form and with dimensions of 6-7 nm. The Ag and Pd particles are shown in FIG. 9A, a high resolution dark field TEM image. The experimental set-up was the same as in Example 3. FIGS. 9B-C are graphs of the hydrogen production, carbon dioxide production and solar to hydrogen efficiency. FIG. 9B is a graph of hydrogen production from water, in presence of 5 vol. % of glycerol, as a function of time over Ag—Pd/TiO₂ catalysts. In FIGS. 9B and 9C, data 900 is 0.3 wt. % Ag and 0.1% Pd on TiO₂ and data 902 is 0.1 wt. % Ag and 0.3% Pd on TiO₂. As was seen by the very high rate of reaction of 1.1×10⁻³ as determined by the slope of the line (y/x) in FIG. 9B, the activity of the catalyst was outstanding. It is believed that the catalysts exceed any known catalytic activity in the field upon excitation of light with UV intensity equivalent to that provided from the sun. FIG. 9C is a graph of CO₂ production as function of time for the same catalysts in FIG. 9B. FIG. 9D is a graph of the solar to hydrogen efficiency as a function of amount of catalysts for 0.1 wt. % Ag-0.3 wt. % Pd/TiO₂ conducted with a light composed of both UV and Visible photons and with intensity close to that of the sun hitting the earth surface at midday (total UV+Vis flux=about 100 mW/cm2).

1. A photocatalyst comprising:
a photoactive material comprising titanium dioxide particles having an anatase to rutile ratio of greater than or equal to 2:1; and
a metal material comprising silver, palladium, and gold, wherein the molar ratio of gold to palladium is from 0.1 to 5 and the molar ratio of gold to silver is from 0.1 to 3,
wherein the metal material is deposited on the surface of the photoactive material.

2. The photocatalyst of claim 1, wherein the titanium dioxide particles comprise a mixture of anatase particles and rutile particles.

3. The photocatalyst of claim 2, wherein the anatase particles have particle sizes between 5 and 50 nanometers and the rutile particles have particle sizes between 20 and 100 nanometers, or wherein the anatase particles have an average particle size of 7 to 10 nanometers and the rutile particles have an average particle size of 20 to 30 nanometers.

4. The photocatalyst of claim 3, wherein the titanium dioxide particles further comprise brookite particles.

5. The photocatalyst of claim 4, wherein the brookite particles are in the form of nano-rods having an average length of 10 to 100 nm and an average width of less than 20 nanometers.

6. The photocatalyst of claim 1, wherein the molar ratio of gold to palladium is about 1 to 3 or the molar ratio of gold to silver is about 1 to 1 or the molar ratio of gold to palladium is about 1 to 3 and the molar ratio of gold to silver is about 1 to 1.

7. The photocatalyst of claim 1, wherein the metal material comprises silver particles, palladium particles, gold particles, tertiary alloy particles of gold, palladium, and silver, binary alloy particles of gold and palladium, or binary alloy particles of gold and silver, or any combination thereof provided that each of silver, palladium, and gold are comprised in the metal material.

8. The photocatalyst of claim 7, wherein the silver particles have an average particle size of less than 10 nanometers, the palladium particles have an average particle size of less than 2 nanometers, the gold particles have an average particle size of less than 5 nanometers, the tertiary alloy particles of gold, palladium, and silver have an average particle size from 5 to 10 nanometers, the binary alloy particles of gold and palladium have an average particle size from 5 to 10 nanometers, or the binary alloy particles of gold and silver have an average particle size from 5 to 10 nanometers, or the binary alloy particles of silver and palladium have an average particle size from 0.5 to 10 nanometers.

9. The photocatalyst of claim 1, wherein the photoactive material further comprises Si⁴⁺ in an amount of less than 5 wt. %.

10. The photocatalyst of claim 1, wherein the gold and palladium are capable of trapping electrons from the conduction band of the titanium dioxide particles.

11. The photocatalyst of claim 1, comprising less than 5 wt. % of the metal material.

12. The photocatalyst of claim 1, wherein the metal material does not cover more than 50% of the surface area of the photoactive material.

13. The photocatalyst of claim 1, wherein the titanium dioxide particles and the metal material are each in the form of nanostructures.

14. (canceled)

15. The photocatalyst of claim 1, wherein the photocatalyst is deposited onto a substrate selected from an indium tin oxide substrate, a stainless steel substrate, a silicon oxide substrate, an aluminum oxide substrate, a zirconium oxide substrate, or a magnesium oxide substrate.

16. (canceled)

17. The photocatalyst of claim 1, wherein the photocatalyst is comprised in an anode of an electrochemical cell capable of forming oxygen and hydrogen by electrolysis of water.

18. (canceled)

19. The photocatalyst of claim 1, wherein the photocatalyst is comprised in an aqueous composition comprising:
0.1 to 2 g/L of the photocatalyst, and
1 to 10 w/v % of a sacrificial agent selected from methanol, ethanol, propanol, methyl tertio-butyl ether, ethylene glycol, propylene glycol, glycerol, or oxalic acid, or any combination thereof.

20-26. (canceled)

27. A method of producing hydrogen gas by photocatalytic electrolysis, the method comprising:
irradiating an aqueous electrolyte solution with light in an electrolytic cell having an anode and a cathode, the anode comprising the photocatalyst of claim 1, whereby a voltage between the anode and the cathode is produced and water molecules are split to form hydrogen and oxygen.

28. The method of claim 27, wherein the hydrogen production rate is between 5×10⁻⁵ to 5×10⁻⁴ mol/g_{Catal} min.

29-33. (canceled)

34. A photocatalyst comprising:
a photoactive material comprising titanium dioxide particles having an anatase to rutile ratio of greater than or equal to 2:1; and
a metal material comprising silver and palladium, wherein the molar ratio of silver to palladium is from 0.1 to 5,
wherein the metal material is deposited on the surface of the photoactive material.

35. The photocatalyst of claim 34, wherein the silver and palladium are a binary alloy having an average particle size of 0.5 nm to 10 nm and the titanium dioxide particles have at least one dimension of 6 nm to 7 nm.

36-38. (canceled)
